(19) United States
(12) Patent Application Publication
(10) Pub. No.: US 2016/0045053 A1
(43) Pub. Date: Feb. 18, 2016

(54) Detachable Pivoting Handle For Gripping a Cookware Vessel

(71) Applicants: Stanley Kin Sui CHENG, (US); MEYER INTELLECTUAL PROPERTIES LTD., Kowloon (HK)

(72) Inventor: Stanley Kin Sui Cheng, Hillsborough, CA (US)

(21) Appl. No.: 14/778,914

(22) PCT Filed: Apr. 4, 2014
(86) PCT No.: PCT/US2014/032897

§ 371 Date: Sep. 21, 2015

Related U.S. Application Data
(60) Provisional application No. 61/808,471, filed on Apr. 4, 2013.

(51) Int. Cl. A47J 27/00; B65D 25/28

(52) U.S. Cl. CPC A47J 27/002; B65D 25/28; B65D 2525/285

(57) ABSTRACT

A detachable handle for a cookware article has a hinged coupled upper and lower handle. A jaw like grip at the front of the handle engages a flange like rim or appendage of the cooking vessel when the lower handle is rotated bring it parallel to the upper handle.

### CROSS REFERENCE TO RELATED APPLICATIONS

The present application claims the benefit of priority to the International (PCT) patent application of the same title having International Appl. No. PT/US2014/032897, with the International filing date of Apr. 4, 2014, as well as the U.S. Provisional Patent application of the same titled that was filed on Apr. 4, 2013, having application Ser. No. 61/808,471, both of which are incorporated herein by reference.

### BACKGROUND OF INVENTION

The present invention relates to a cookware articles, and in particular to a handle that is detachable from pots and pans.

Of the numerous variations in prior art detachable handles for cookware, considerable mechanical complexity is required within the handle device, as well as a particular structure for engaging the cookware vessel, usually in outward extending flange it has a lockable mating feature design to engage in internal fixture of the detachable handle.

Such devices tend to exhibit considerable mechanical “play”, even when securely holding the vessel, which can make users or consumers feel insecure in their use.

Further, the receiving fixture that extends outward from the cooking vessel for lockable engagement with an attachable handle usually precludes shipping or storing the cookware vessels in any set of various sizes within a nested arrangement that can save space.

It is therefore a first object of the present invention to overcome the above deficiencies of the prior art, as well as provide additional benefits described in further detail below.

### SUMMARY OF INVENTION

In the present invention, the first object is achieved by providing a detachable cookware handle comprising an upper handle, a lower handle, a lower jaw in pivoting attachment at an upper axle to a front axle of the upper jaw, and in pivoting attachment at a lower axle to a forward axle of the lower handle, a pivoting linkage coupled with the upper and lower handle, having a proximal axle providing a pivoting attachment to a rear axle of the lower handle and a distal axle in pivoting attachment to the back axle of the upper handle.

A second aspect of the invention is characterized in that the lower jaw has a recess behind a black planar portion formed forward of the pivoting connection to the upper and lower handles.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A is a side elevation view of the detachable handle connected to a cookware vessel, in which the cookware vessel is shown in section.

FIG. 1B is a side elevation view of the detachable handle in FIG. 1A after opening for removal from the cookware vessel.

FIG. 2 is an exploded perspective view of another embodiment of the detachable handle illustrated in more detail the pivoting connections of the various components.

FIG. 3A is a top plan view of a preferred embodiment of the lower jaw component, whereas FIG. 3B is a side elevation view thereof with FIG. 3C being a corresponding side elevation cross-sectional view of a preferred embodiment of a cookware vessel flange

FIG. 4A is a cross-sectional elevation of a more preferred embodiment of the handle's taken transverse to the primary access of the upper and lower handles, Whereas FIG. 4B is an exterior elevation of a more preferred embodiment of the forward shore portion of the detachable handle gripping the vessel flange shown in FIG. 3C.

FIG. 5A is a perspective view of an alternative embodiment of the handle engaged in the locked position on the rim of a cookware vessel, whereas FIG. 5B is a alternative perspective view of the same embodiment facing the grip portion of the handle and omitting the vessel.

FIG. 6A is a top plan view of the handle of the embodiments of FIGS. 5A and 5B. FIG. 6B is a side elevation view of FIG. 5A, whereas FIG. 6C is a side elevation view of the handle and the open position.

FIG. 7A is a side elevation view of the handle of the embodiments of FIGS. 5 and 6 shown in a locked position on the cookware vessel the embodiments of FIGS. 5 and 6 including the cookware vessel, whereas FIG. 7B is a corresponding side elevation in which the handle has been opened or released from the cookware vessel, and FIG. 7C is a cross-sectional elevation of the handle portion shown by section line C-C FIG. 7A.

### DETAILED DESCRIPTION

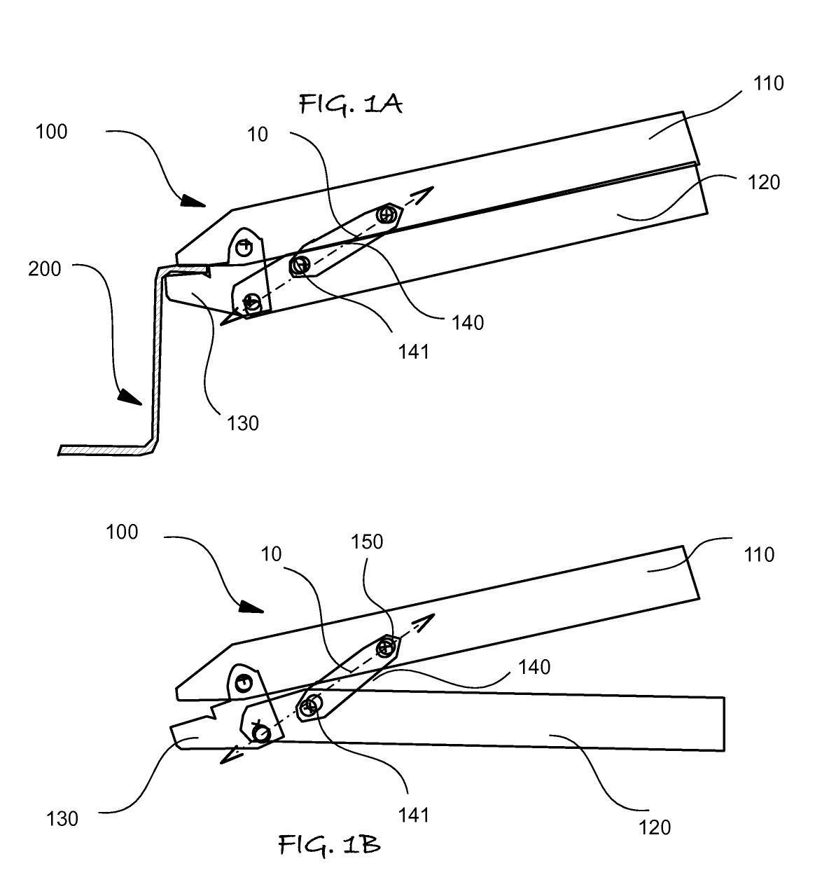

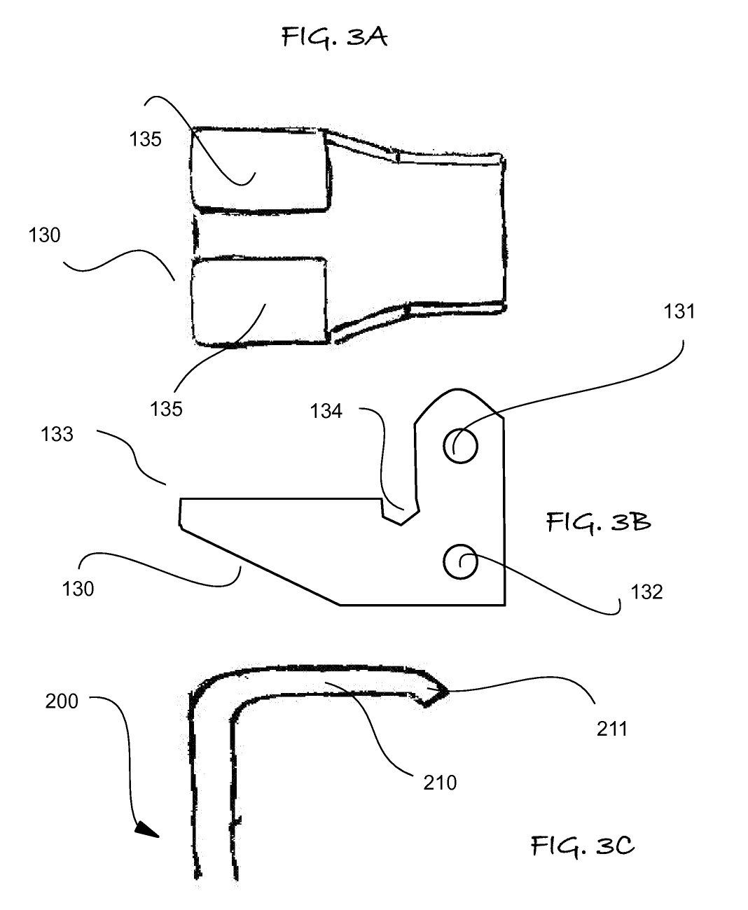

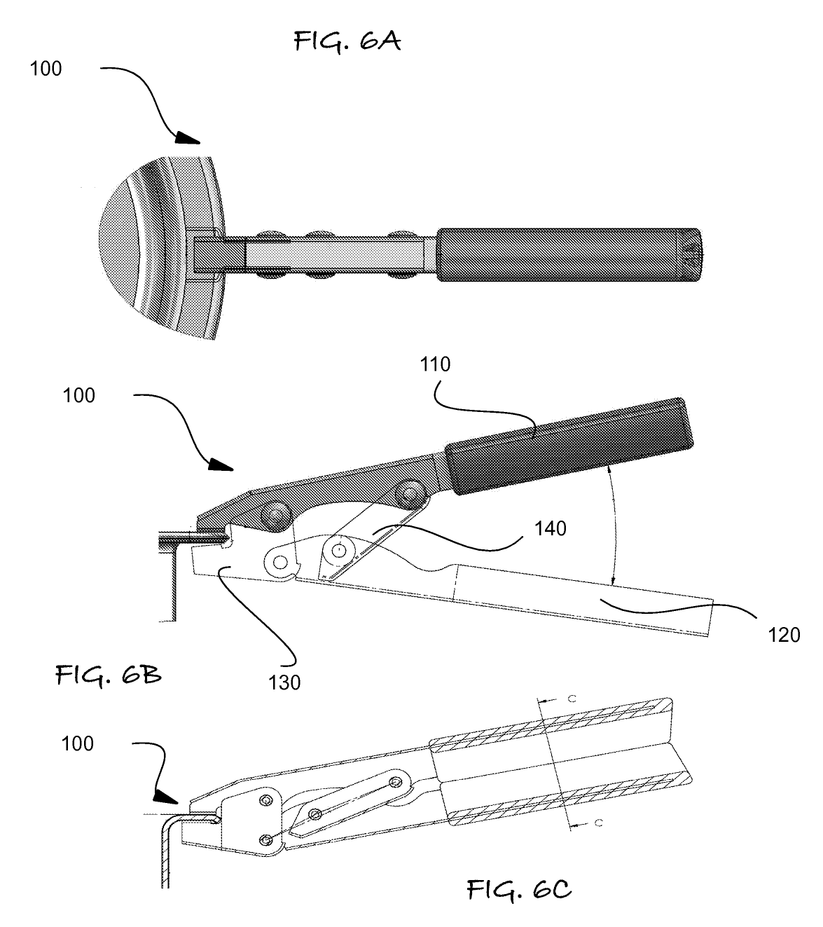

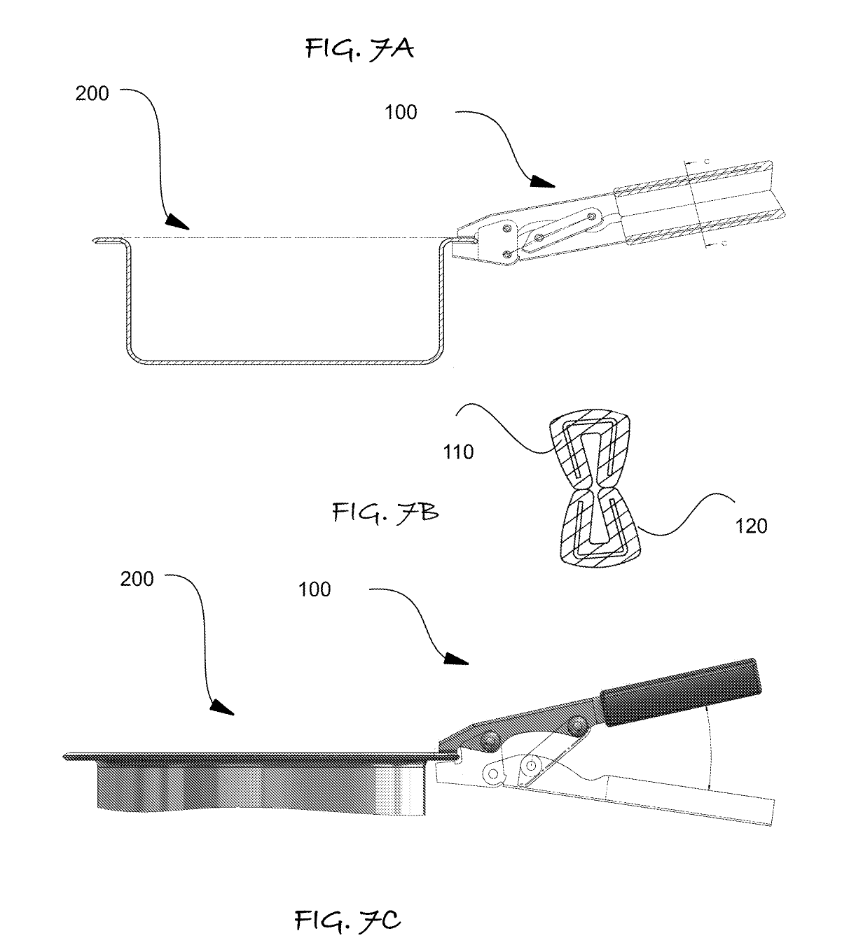

Referring to FIGS. 1 through 7, wherein like reference numerals refer to like components in the various views, there is illustrated therein a new and improved detachable handle for gripping a cooking vessel, generally denominated 100 herein.

In accordance with the present invention the detachable cooking handle deploys an upper handle 110 which is coupled in hinged engagement to a lower handle 120 via a lower jaw 130 and a link or linkage arm 140.

More specifically, both the lower jaw 130 and the link 140 are both in pivoting attachment to the upper 110 and lower handle 120 via common axles, which are preferably provided by compression rivets that extends through holes formed in each of the components. The common axles are generally referred to by reference numerals 150. Compression rivets 150 are formed by inserting the narrow cylindrical portion of rivet head 151 into the open cylindrical portion of the opposing rivet half 152, forming a strong compression fit and bond, such that the head of each half of the rivet 150 extends beyond the hole in the component.

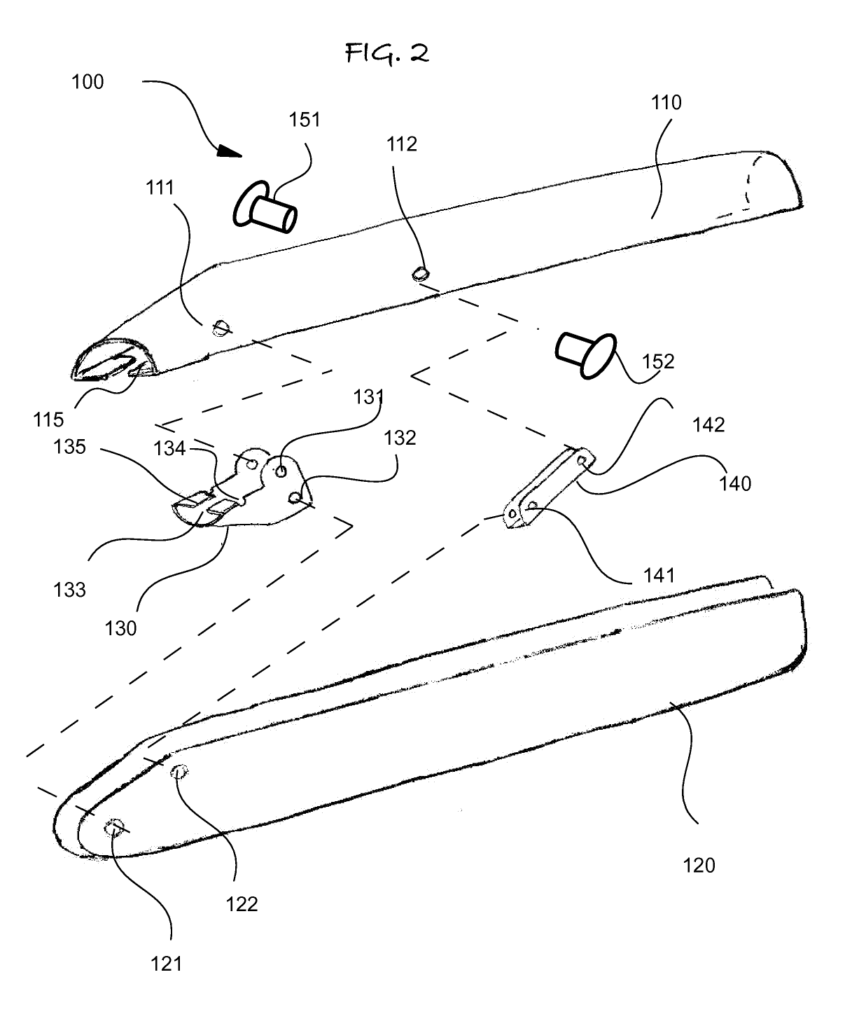

As illustrated in more detail in FIG. 2, the detachable cookware handle has an upper handle or grip 110, and a lower handle or grip 120 both of which are coupled to the lower jaw 130 in pivoting attachment. The lower jaw 130 is connected by at an upper axis 131 (defined by holes for receiving rivets) to a front axle 111 on the upper handle 110. The front axle 111 is formed by a rivet through corresponding pair of holes on opposing sides of the upper handle 110. The portion of the upper handle 110 in front of the axle 111 is a jaw forming portion that mates with a similar planar portion of the lower jaw 130 when the handles 110 and 120 are closed (FIG. 1A) to grip cookware. The lower jaw 130 is also connected in pivoting attachment at a lower axis 132 to a forward axle 121 of the lower handle 120. The pivoting linkage 140 couples the upper 110 and lower handle 120, having a proximal axle 141, provides a pivoting attachment to a rear axis 122 of the lower handle 120 and a distal axle 142 in pivoting attachment to the back axis 112 of the upper handle 110.

In the most preferred embodiments all of the above pivoting axles are provided by compression rivets, which are generally denominated 150, form by first and 2nd rivet components 151 and 152 respectively.

A recess 134 is preferably provided behind a planar upper face 133 of the lower jaw 130. The forward portion of the upper handle 110 comprises a downward facing lower surface that forms an upper jaw gripping surface 115 that opposes the upper planar surface 135 of the lower jaw 130. These opposing jaw surfaces 115 and 135 are intended to grasp either a flange or appendage extending outward from a cookware vessel 200 the upper 110 and lower 120 handle are brought together.

In the most preferred embodiments the outer periphery of the cookware vessel's annular flange 210 has a turned downed edge 211 or bead with the thickness of about 1 to 2 mm for engagement within the recess 134 behind the planar face 135 of the lower jaw 130.

It should be appreciated that multiple cookware vessels 200 are included with the detachable handle as a kit. Each vessel can be designed on a comparable or decreasing diameter than the largest vessel in the kit, but generally progressively lower height so the smaller vessels can nest within each progressively larger vessel.

The flange 210 on the vessel 200 is either integral or welded to the sidewall of the vessel 200. Such a flange 210 preferably has a width of between about 15 to 30 mm, so it can also be grasped or moved with other implements when it is not necessary to actually lift the cookware vessel 200.

Further, any of the above the detachable handle components are readily formed by bending and folding sheet metal, with the holes for receiving the axles 150 being drilled either before or after forming.

It should be appreciated that the forward portion of the upper handle provides a generally planar upper jaw 115 that opposes a corresponding planar forward portion of the lower jaw 130 for grasping a horizontal flange 210 or appendage extending from either the rim or sidewall of the cookware vessel 200.

Each of the planar upper jaw 115 or lower jaw 135 are readily formed by bending or forging portions or tabs of sheet metal that forms major portion of the corresponding component.

The inventive detachable handle 100 has self latching characteristics which are provided by the appropriate spacing of the forward axle, rear axle and back axle arrangement so that upon bringing the upper and lower handle together to close the jaw on the flange provide a secured latched attachment to vessel. When the handles are brought together in the closed arrangement for gripping, the rear axle is displaced to slightly above the line 10 that extends between the forward axle and the back axle; in contrast when the handles are separated to release the cookware vessel the rear axle is vertically disposed downward below this line 10. The flexibility of stainless steel provides stability of the device between the opposing settings such that a positive separation force is required to open the detachable handle once closed.

Depending on the particular construction of the detachable handle a spring or additional means may be provided to enhance the latching capability of the device, that is requiring less force to initiate closure into the gripping positions shown in FIG. 1A or separating the latched upper and lower handle portions into the open position shown in FIG. 1B.

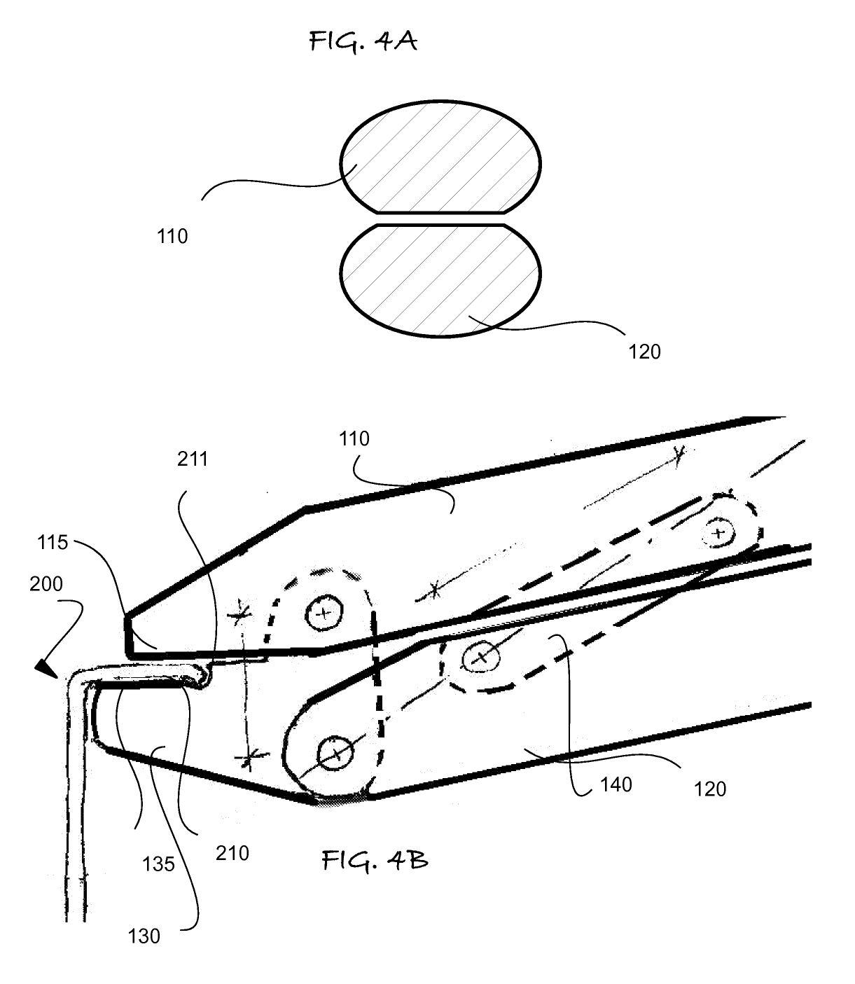

It should be further appreciated that the cross-sectional shape of each handle is preferably optimized for gripping and pulling apart to detach the handle without risk of pinching the skin on the palm of the hand, as is illustrated in FIG. 4A. It is preferable that each of the upper and lower handles has a wider face distal from the faces of each of the upper and lower handles that approach each other as the jaws are closed to grip the flange of a cookware vessel.

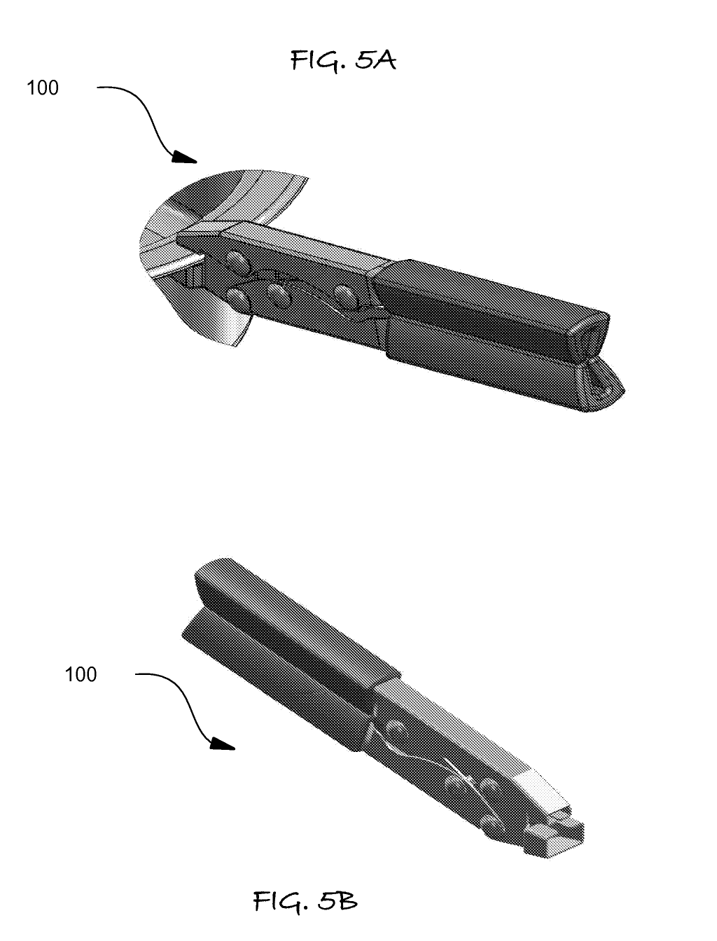

FIGS. 5 through 7 illustrate more preferred embodiments of the inventive handle it locked and unlocked positions, with the wider grips. The grips are preferably covered with a soft rubber or elastic material to provide user comfort and non-slip properties. These embodiments also have complimentary S-shaped curvilinear portion of the upper and lower handles between the axles 131 and 112.

Hence, the various combination of the above embodiments generally provide the following benefits:

1. secure gripping of the cookware vessel without “play”

2. a vessel set that deploys the detachable handle can be readily stacked for compact storage

3. Simple operation, with a readily visibly apparent confirmation that the cookware vessel is firmly grasped by the detachable handle.

4. Simple construction

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. An article of cookware, comprising:
a) a substantially horizontal bottom,
b) substantially upright sidewall extending upward from and encircling said bottom to form a fluid retaining interior region, the sidewalls terminating at an upward rim of the vessel,
c) an outward extending annular flange connecting to the upright sidewall at the rim of the vessel
d) at least one detachable handle extending outward from said flange that is selectively connected thereto by a clamping jaw assembly formed by an upper and lower handle that pivotally engage via a linkage coupling, wherein the annular flange has a bead at the periphery thereof and the clamping jaw has a forward planar portion to grasp the annular flange and a recess behind the forward planar portion to receive the bead at the periphery of the annular flange.

2. The article of cookware according to claim 1 wherein the linkage coupling is a pivoting linkage coupled with the upper and lower handle, having a proximal axle providing a pivoting attachment to a rear axle of the lower handle and a distal axle in pivoting attachment to the back axle of the upper handle.

3. A cookware kit comprising:
a) a first and second cookware vessel, each having;
i) a substantially horizontal bottom,
ii) substantially upright sidewall extending upward from and encircling said bottom to form a fluid retaining interior region, the sidewalls terminating at an upward rim of the vessel,
iii) an outward extending annular flange connecting to the upright sidewall at the rim of the vessel,
b) a detachable cookware handle having;
i) an upper handle,
ii) a lower handle,
iii) a lower jaw in pivoting attachment at an upper axle to a front axle of the upper jaw, and in pivoting attachment at a lower axle to a forward axle of the lower handle,
iv) a pivoting linkage coupled with the upper and lower handle, having a proximal axle providing a pivoting attachment to a rear axle of the lower handle and a distal axle in pivoting attachment to the back axle of the upper handle.

4. The cookware kit according to claim 3 wherein the annular flange on each cookware vessel of the kit has a bead at the periphery thereof and the clamping jaw assembled portion formed by the upper jaw has a recess to receive the bead portion.

5. The cookware kit according to claim 3 wherein one of the first and second cookware vessel is shorter than the other and the shorter vessel is narrower than the other to next within.

6. A detachable cookware handle comprising:
a) an upper handle,
b) a lower handle,
c) a lower jaw in pivoting attachment at an upper axle to a front axle of the upper jaw, and in pivoting attachment at a lower axle to a forward axle of the lower handle,
d) a pivoting linkage coupled with the upper and lower handle, having a proximal axle providing a pivoting attachment to a rear axle of the lower handle and a distal axle in pivoting attachment to the back axle of the upper handle.

7. A detachable handle according to claim 6 in which the upper and lower handle are wider at the outer opposing sides that are distal from the closer opposing sides.

8. A detachable handle according to claim 6 in which the upper and lower handles are covered with a soft rubber or elastic material to provide user comfort and non-slip properties.

9. A detachable handle according to claim 6 in which upper and lower handles between the lower jaw and the rear axle of the lower handle have complimentary S-shaped curvilinear portions that mate when the jaw portion is closed.
